(19) United States
(12) Patent Application Publication
(10) Pub. No.: US 2008/0196786 A1
(43) Pub. Date: Aug. 21, 2008

(54) Method and Apparatus for the Phase Change in an Isolator

(76) Inventors: Volker Sigwarth, Sisseln (CH); Reto Specht, Breitenbach (CH); Markus Sollberger, Kyburg-Buchegg (CH); Thomas Neuschwander, Arlesheim (CH)

Correspondence Address: MCCARTER & ENGLISH, LLP, FOUR GATEWAY CENTER, 100 MULBERRY STREET, NEWARK, NJ, 07102, US

(21) Appl. No.: 11/596,608

(22) PCT Filed: Apr. 21, 2005
(86) PCT No.: PCT/CH05/00222

§ 371 Date: Feb. 26, 2008

(30) Foreign Application Priority Data
May 20, 2004 (CH) 872/04

(51) Int. Cl. B65B 1/04; B65B 1/28; B65B 31/02; B01L 1/00

(52) U.S. Cl. 141/4; 141/11; 141/67; 141/69; 141/98; 141/285; 454/187

(57) ABSTRACT

The invention relates to a method and an installation for controlling the pressure in a working chamber (10) of an insulator (1), which is shielded from the outer environment (U), during opening or closing of the insulator with respect to the outer environment (U), with the aim of avoiding critical pressure bursts in the working chamber (10). The working chamber (10) is provided with an access for introduction or removal of the product to be treated. Purified air is supplied to the working chamber (10) from a circulating air Zone (11), and air arrives from the working chamber (10) at the circulating air Zone (11) via a returning air channel (14), and the working chamber and the circulating air Zone form an interior space (18). A supply air unit (a3) is provided on the insulator (1) and comprises a supply air ventilator (B) and a blockable first supply air adjusting element (21), mounted between the supply air ventilator (B) and the interior space (18). The insulator (1) is also provided with a discharge air unit (b6) which comprises a discharge air ventilator (B) and a blockable first discharge air element (31), mounted between the discharge air ventilator (B) and the interior space (18). Phase change is carried out as a change-over process on the first supply air element (21) and the first discharge air element (31), from the closed to the open state or vice versa, using the following steps: measuring the differential pressure at both ends of the first supply air element (21) and/or at both ends of the first discharge air element (31); adjusting at least theoretically identical pressures at both ends of the first supply air element (21) and/or at both ends of the first discharge air element (31); carrying out the change-over process on the first supply air element (21) and first discharge air element (31).

### APPLICATION FIELD OF THE INVENTION

The invention relates to a method for pressure regulation in an isolator which has a working chamber which is shielded from the external surrounding area. The working chamber in isolators such as these is supplied with a clean, preferably low-turbulence, displacement flow. Isolators are operated in two fundamentally different applications. In the first case, a product which is handled therein must be protected in the working chamber against contamination from the area surrounding the isolator, for example when carrying out sterility tests on pharmaceutical products. In order to ensure this, the working chamber is operated in an hermetically sealed form at a pressure which is higher than the surrounding area, so that, in the event of leakage damage, the pressure gradient cannot possibly result in any environmental air flowing from the exterior into the working chamber.

In the second case, toxically loaded products are being handled in the working chamber, in which case no hazardous substances may be allowed to enter the surrounding area from the chamber, for example during toxic substance filling processes or during research experiments. In order to ensure these conditions, the working chamber is operated at a pressure that is less than that in the surrounding area. This ensures that, in the event of leakage damage, it would only be possible for surrounding area from the outside to enter the working chamber, and that no flow can take place in the opposite flow direction.

In particular, the invention relates to a method for pressure regulation in the working chamber during a phase change, that is to say during opening or closing of the isolator with respect to the surrounding area, as practiced in particular during the changeover from the decontamination process, which is carried out in the closed state, to the rinsing process when the isolator is open. The invention furthermore relates to an apparatus for carrying out the method for operation of the isolator.

### PRIOR ART

FIGS. 1A to 1E illustrate an arrangement which has been used in the past. The working chamber 10 which is intended for handling of products in clean-room conditions is located in the interior of a housing, which bounds the isolator 1 from the external surrounding area U and rests on a subframe 15. The air circulation zone 11 is located above the working chamber 10, with a separating wall 12 being provided between the working chamber 10 and the air circulation zone 11. The working chamber 10 has at least one access (not illustrated here) for introduction and removal of the product to be handled. At the side, the working chamber 10 has an intermediate wall 13, behind which the return air channel 14, which is separated from the external surrounding area U by the housing wall, extends upwards. The return air channel 14 opens at the level of the separating wall 12 into the air circulation zone 11, and starts in a lower area of the working chamber 10. Together with the air circulation zone 11 and the return air channel 14, the working chamber 10 forms the internal area 18. Three air circulation units c0 are arranged at equal distances alongside one another in the air circulation zone 11 and each comprise a fan B, which is driven by a motor M, a filter plenum Fp adjacent to it downstream, and a downstream air filter F. An operator who is working on the isolator 1 can enter the working chamber 10, and can grip products to be handled by means of conventional gloves, which are not illustrated but are accessible via the access openings 17, via the access unit Z in the front panel 16.

During the operation, the fans B in the air circulation units c0 suck in air from the air circulation zone 11, and feed this air first of all into the adjacent filter plenums Fp, from where the air flows on through the adjacent air filters F into the working chamber 10. The air supply unit a0 for supplying and cleaning fresh air, as well as an exhaust air unit b0 as an outlet for the air mixture, which comprises loaded air that has been fed back from the working chamber 10 as well as fresh air that has been added, are located at the top on the isolator 1, outside the internal area 18. The air supply unit a0 comprises a fan B, which is driven by a motor M, sucks in air from the surrounding area U and feeds it into the adjacent filter plenum Fp, with this being followed by the filter F. The clean air flows via the outlet flow area 20 into the supply line 2 via its front supply line section 28 to a first air supply actuating member 21, which is operated by a first air supply actuating drive 22 between being completely open and being completely shut off. Finally, the air enters the air circulation zone 11 via a rear supply line section 29.

Air is passed via the front exhaust line section 38 of the exhaust line 3 from the air circulation zone 11 to the first exhaust air actuating member 31, which is operated by the first exhaust air actuating drive 32 between being completely open and being completely shut off.

The fan B in the air supply unit a0 and the fan B in the exhaust air unit b0 are operated with different air feed powers for pressure regulation in the working chamber 10 when the first exhaust air actuating member 31 and the first air supply actuating member 21 are open. If one wishes to raise the pressure in the working chamber 10, then the fan B in the air supply unit a0 is operated at a higher air feed power than the fan B in the exhaust air unit b0, so that more air is supplied to the internal area 18 than is taken from it and, in consequence, the pressure in the internal area 18 rises. In consequence, the fan B in the exhaust air unit b0 is operated at a higher air feed power than the fan B in the air supply unit a0 when the aim is to reduce the pressure in the working chamber 10. In this case, the amount of air which is carried away from the internal area 18 predominates, that is to say the pressure in the internal area 18 falls.

The rear exhaust line section 39 is connected to the first exhaust air actuating member 31, and is connected to the associated fan B, which is driven by the motor M, in the exhaust air unit b0. The fan B supplies the loaded air via the filter plenum Fp to the air filter F, in order to be released from here into the surrounding area U having been cleaned, after passing through the outlet flow area 30.

A decontamination system which is not illustrated but is known per se and has an evaporator is generally provided in the internal area 18 of the isolator 1, preferably in the air circulation zone 11, by means of which the isolator 1 is sterilized—in the case of specific working processes together with the product that has been introduced. For this purpose, the evaporator is fed with a suitable decontamination agent, such as hydrogen peroxide.

During the decontamination phase, the air supply line 2 and the exhaust air line 3 are closed to be gas-tight by the respective first air supply actuating member and exhaust air actuating member 21,31. The isolator equipment shown here offers no capability to regulate the pressure in the working chamber 10 in the closed state, and this also relates to the pressure fluctuations which occur suddenly in the event of a phase change, which propagate into the working chamber 10 and, in an overcritical case, can even lead to brief inversion of the safety pressure gradient to be maintained with respect to the surrounding area U. This hardware configuration thus no longer actually complies with the present-day stringent safety regulations and process requirements.

FIGS. 2A to 2D

As a further development, the applicant then equipped isolators with added two-point control, which allows pressure regulation in the working chamber 10 even when the isolator 1 is closed, that is to say when the first air supply and exhaust air actuating members 21,31 are shut off. The pressure in the working chamber 10 is kept within a tolerance band between a maximum value and a minimum value as a discrepancy from a predetermined nominal value. For example, the isolator 1 is operated with a nominal differential pressure value with respect to the external surrounding area U of Δpₙₒₘ=60 Pa, with the minimum differential pressure being Δpₘᵢₙ=20 Pa and the maximum differential pressure being Δpₘₐₓ=120 Pa.

Initially, the two-point control comprises a compressed-air unit d, which has a compressed-air source 5 and a compressed-air line 57 which extends from there into the air circulation zone 11. A compressed-air actuating member 51 is installed in the compressed-air line 57, and is connected to a compressed-air actuating drive 52. The two-point control optionally includes an adjustment line 56, which originates from the exhaust flow area 20 of the air supply unit a0, and opens into the compressed-air line 57 between the compressed-air source 5 and the compressed-air actuating member 51.

The exhaust-air unit b4, which is located in the same way as the air supply unit a0 outside the internal area 18, has, in comparison to the already described exhaust air unit b0, a second exhaust air bypass 35 added to it, which opens into the filter plenum Fp of the air circulation unit c1, which is arranged under the exhaust air unit b4, bypassing the first exhaust air actuating member 31, and in which a third exhaust air actuating member 36 is provided, and is connected to a third exhaust air actuating drive 37. The two-point control also includes a pressure sensor 43 in the working chamber 10, which is coupled via a signal line 42 to the two-point regulator 4 and itself acts via the signal line 42 on the third exhaust air actuating drive 37 and the compressed-air actuating drive 52.

If the pressure in the working chamber 10 exceeds the maximum permissible pressure Δpₘₐₓ, the two-point regulator 4 acts on the third exhaust air actuating drive 37, which opens the third exhaust air actuating member 36, so that air is carried away from the filter plenum Fp of the air circulation unit c1 via the second exhaust air bypass 35 and until the nominal value Δpₙₒₘ has been reached in the working chamber 10, after which the third exhaust air actuating member 36 closes again.

If the pressure in the working chamber 10 falls below the minimum permissible pressure Δpₘᵢₙ, the two-point regulator 4 acts on the compressed-air actuating drive 52, which opens the compressed-air actuating member 51, in response to which compressed air is supplied via the compressed-air line 57 to the air circulation zone 11, and in consequence to the working chamber 10, until the nominal value Δpₙₒₘ is reached, after which the compressed-air actuating member 51 closes again.

An alternative way to raise the pressure in the working chamber 10 to the nominal value Δpₙₒₘ is for the two-point regulator 4 to drive the compressed-air actuating drive 52 to open the compressed-air actuating member 51 if the pressure falls below Δpₘᵢₙ, and to operate the fan B in the air supply unit a0—if this is switched off. The fan B feeds air through the filter plenum Fp and the air filter F into the exhaust flow area 20, from where the air passes via the adjustment line 56, the compressed-air line 57 and the compressed-air actuating member 51 into the air circulation zone 11. Once the nominal value Δpₙₒₘ has been reached in the working chamber 10, the two-point regulator 4 closes the compressed-air actuating member 51, and the fan B could be switched off.

In comparison to the exhaust air unit b0, the exhaust air unit b4 also has a safety line 350 added to it, which originates from the air circulation zone 11, opens into the second exhaust air bypass 35, and is equipped with a safety valve 360. If Δpₘₐₓ is critically exceeded in the air circulation zone 11, for example as a consequence of an excessive amount of air being supplied via the compressed-air line 57 and not being carried away adequately via the second exhaust air bypass 35 because of a defect, the safety valve 360 opens automatically. This two-point control is suitable for stabilization of the pressure in the working chamber 10 in a predetermined range when the first air supply and exhaust air actuating members 21,31 are in the closed state. However, during closure, and in particular during opening, of the first air supply and exhaust air actuating members 21,31, sudden pressure fluctuations occur in the working chamber 10. When the first air supply and exhaust air actuating members 21,31 are closed, considerable pressure differences in each case occur on both sides of these fittings—downstream before and after them. When the first air supply and/or exhaust air actuating members 21,31 are opened suddenly, as is the case shortly before the flushing phase after decontamination of the isolator 1, this results in sudden pressure equalization with the air masses flowing over like a flood from the high-pressure area into the low-pressure area.

If the pressure on that side of the first exhaust air actuating member 31 which faces the external surrounding area U is lower than that on the opposite side, the equalizing flow of the air masses takes place in the direction of the external surrounding area U. This results in a vacuum-pressure wave, which propagates quickly via the air circulation zone 11 into the working chamber 10, with the pressure in the working chamber 10 failing abruptly below the minimum value Δpₘᵢₙ. If the pressure on that side of the first air supply actuating member 21 which faces the external surrounding area U is higher than the pressure on the opposite side, the equalizing flow of the air masses flows into the isolator 1. The increased-pressure wave that this results in propagates via the air circulation zone 11 into the working chamber 10, so that the pressure here jumps suddenly above the maximum value Δpₘₐₓ. This results in an increased risk of decontamination agents entering the surrounding area U if there are any leaks in the isolator 1.

In contrast, a phase change from the air supply and exhaust air actuating members 21,31 being open to being in their shut-off state is less problematic, because the isolator 1 is already contaminated at the end of a working process, and is being prepared for decontamination.

### OBJECT OF THE INVENTION

With regard to the further risk that is not coped with, on the basis of which, in particular during opening of the isolator for example in the transition from decontamination to flushing or other phase changes, in which the bandwidth of safe pressure difference from the surrounding area with a hazard to personnel is broken through by enormous pressure fluctuations in the working chamber, the object of the invention is to specify a method which can be used to prevent, or at least largely reduce, the pressure fluctuations during opening and closing of the isolator. The aim is therefore for the pressure in the working chamber no longer to leave the range between the maximum and minimum values which must be complied with for safety reasons.

A further object is to propose the hardware means for carrying out the method for elimination of the critical pressure fluctuations when a phase change occurs during operation of the isolator.

### SUMMARY OF THE INVENTION

The method relates to pressure regulation in a working chamber, which is shielded from the external surrounding area, in an isolator during opening or closing of the isolator, with respect to the external surrounding area. The working chamber has an access for introduction and removal of the product to be handled. The isolator has an air circulation zone from which clean air is supplied to the working chamber. Air is fed back into the air circulation zone from the working chamber via the return air channel. The working chamber, the air circulation zone and the return air channel together form an internal area. An air supply unit is provided on the isolator and has an air supply fan and a first air supply actuating member, which can be shut off and is arranged between the air supply fan and the internal area. An exhaust air unit with an exhaust air fan and a first exhaust air actuating member, which can be shut off and is arranged between the exhaust air fan and the internal area, is provided on the isolator.

The characteristic feature of the method is that the phase change is carried out as a switching process at the first air supply actuating member and the first exhaust air actuating member from the closed state to the open state, or vice versa, in the following steps:
1. Measurement of the differential pressure on both sides of the first air supply actuating member and/or on both sides of the first exhaust air actuating member;
2. Production of at least in principle equal pressures on both sides of the first air supply actuating member and/or on both sides of the first exhaust air actuating member; and
3. Carrying out the switching process at the first air supply actuating member and first exhaust air actuating member.

Particularly advantageous details relating to the pressure regulation method are specified in the following text: in order to produce at least in principle the same pressure on both sides of the first air supply actuating member and/or on both sides of the first exhaust air actuating member, when the first air supply actuating member and the first exhaust air actuating member are completely closed, the internal area of the isolator on the air supply unit side and on the exhaust air unit side is in each case opened to the external surrounding area, resulting in the production of an equalizing flow with as little flow resistance as possible.

A first air supply bypass, which bypasses the first air supply actuating member, as well as a second air supply actuating member, which is arranged therein, are used to produce at least in principle the same pressure on both sides of the first air supply actuating member. In a corresponding manner, a first exhaust air by-pass, which bypasses the first exhaust air actuating member, and a second exhaust air actuating member, which is arranged therein, are used to produce at least in principle the same pressure on both sides of the first exhaust air actuating member. Once the differential pressure on both sides of the first air supply actuating member has been determined, the second air supply actuating member is opened wide and the air supply fan is started up with a slowly rising feed power in order to produce the equalizing flow, which is generated from the air supply unit and is directed into the internal area, with as little flow resistance as possible through the first air supply bypass. Additionally or alternatively, after determination of the differential pressure on both sides of the first exhaust air actuating member, the second exhaust air actuating member is opened wide, and the exhaust air fan is started up with the feed power increasing slowly in order to produce the equalizing flow, which is sucked in from the internal area and is directed into the exhaust air unit, with as little flow resistance as possible through the first exhaust air bypass. The switching process at the first air supply actuating member and first exhaust air actuating member takes place after reaching at least in principle the same pressures on both sides of the first air supply actuating member and/or the first exhaust air actuating member.

The differential pressure which is measured on both sides of the first air supply actuating member is transmitted to the installation control unit associated with the first air supply bypass. In order to produce the equalizing flow, as a function of the processed differential pressure, the installation control unit drives a second air supply actuating drive and results in the air supply fan being started up, with the air supply actuating drive operating the second air supply actuating member. After reaching at least in principle the same pressures on both sides of the first air supply actuating member, the installation control unit drives a first air supply actuating drive, which carries out the switching process at the first air supply actuating member.

The differential pressure which is measured on both sides of the first exhaust air actuating member is transmitted to an installation control unit associated with the first exhaust air bypass. In order to produce the equalizing flow, as a function of the processed differential pressure, the installation control unit drives a second exhaust air actuating drive and, on the other hand, results in the exhaust air fan being started up, with the second exhaust air actuating drive operating the second exhaust air actuating member. After reaching at least in principle the same pressures on both sides of the first exhaust air actuating member, the installation control unit drives a first exhaust air actuating drive, which carries out the switching process at the first exhaust air actuating member.

With regard to the compensation of the equalizing flow, a corresponding volume to the amount of air fed from the air supply unit into the internal area is dissipated from the internal area via the exhaust air unit into the external surrounding area, with a two-point regulator regulating the air passing through the exhaust air unit as a function of the pressure in the internal area. A corresponding volume to the amount of air sucked out of the internal area by the exhaust air unit is supplied to the internal area via the air supply unit or a compressed-air unit, with a two-point regulator controlling the air passing through the air supply unit as a function of the pressure in the internal area.

The apparatus that is used for pressure regulation in an isolator having a working chamber which is shielded from the external surrounding area and has an access for introduction and removal of the product to be handled. The isolator also has an air circulation zone from which clean air is supplied to the working chamber, in which air is fed back into the air circulation zone from the working chamber via a return air channel. The working chamber, the air circulation zone and the return air channel together form an internal area. The isolator also has an air supply unit which has an air supply fan and a first air supply actuating member which can be shut off and is arranged between the air supply fan and the internal area. The isolator has an exhaust air unit, which has an exhaust air fan and a first exhaust air actuating member which can be shut off and is arranged between the exhaust air fan and the internal area.

The essence of the apparatus consists in that means are provided for measurement of the differential pressure on both sides of the first air supply actuating member, and means are provided for production of at least in principle the same pressure on both sides of the first air supply actuating member. Additionally or alternatively, means are provided for measurement of the differential pressure on both sides of the first exhaust air actuating member, and means are provided for production of at least in principle the same pressure on both sides of the first exhaust air actuating member.

Particularly advantageous details of the apparatus will be specified in the following text: the means for production of at least in principle the same pressure on both sides of the first air supply actuating member comprise a first air supply bypass which bypasses the first air supply actuating member and has a second air supply actuating member. In a corresponding manner, the means for production of at least in principle the same pressure on both sides of the first exhaust air actuating member comprise a first exhaust air bypass which bypasses the first exhaust air actuating member and has a second exhaust air actuating member. The second air supply actuating member and the second exhaust air actuating member are preferably variably adjustable between being completely shut off and being completely open.

The first air supply actuating member is installed in a supply line which preferably comprises a front and a rear supply line section, with the front supply line section leading to the air supply fan and with the rear supply line section opening into the air circulation zone. The first exhaust air actuating member is installed in an exhaust line which preferably comprises a front and a rear exhaust line section, with the front exhaust line section opening into the air circulation zone, and the rear exhaust air section leading to the air supply fan.

The first air supply bypass extends from the front supply line section into the working chamber, or opens into the rear supply line section. The first exhaust air bypass extends from the rear exhaust line section into the working chamber, or opens into the front exhaust line section.

The means for measurement of the differential pressure on both sides of the first air supply actuating member is a differential pressure sensor which receives pressure signals which are tapped off at measurement points; in which case one measurement point is in each case arranged downstream before the first air supply actuating member, and a further measurement point is arranged downstream behind the first air supply actuating member. One measurement point is in each case arranged downstream before the first exhaust air actuating member, and a further measurement point is arranged downstream behind the first exhaust air actuating member. The differential pressure sensor is preferably integrated at an installation control unit. The means for measurement of the differential pressure on both sides of the first air supply actuating member and/or of the first exhaust air actuating member may also be a flowmeter which is arranged in the first air supply bypass and/or in the first exhaust air bypass.

In the case of the first air supply bypass, which opens into the working chamber, one of the measurement points is arranged in the front supply line section, preferably in the area of the branch for the first air supply bypass, and the further measurement point is arranged in the working chamber, preferably in the area of the opening of the first air supply bypass.

If the first air supply bypass opens into the rear supply line section, then one of the measurement points is arranged in the front supply line section, preferably in the area of the branch of the first air supply bypass, and the further measurement point is arranged in the rear supply line section, preferably in the area of the opening of the first air supply bypass. In the case of the first exhaust air bypass which opens into the working chamber, one of the measurement points is arranged in the rear exhaust line section, preferably in the area of the branch of the first exhaust air bypass, and the further measurement point is arranged in the working chamber, preferably in the area of the opening of the first exhaust air bypass. If the first exhaust air bypass opens into the front exhaust line section, then one of the measurement points is arranged in the front exhaust line section, preferably in the area of the branch of the first exhaust air bypass, and the further measurement point is arranged in the rear exhaust line section, preferably in the area of the opening of the first exhaust air bypass.

The first air supply bypass has an associated installation control unit which is intended for detection of the differential pressure on both sides of the first air supply actuating member and is connected to the air supply fan, to the first air supply actuating member and to the second air supply actuating member. In a corresponding manner, the first exhaust air bypass has an associated installation control unit, which is intended for detection of the differential pressure on both sides of the first exhaust air actuating member, and is connected to the exhaust air fan, to the first exhaust air actuating member and to the second exhaust air actuating member.

The first air supply actuating member is connected to a first air supply actuating drive, preferably an electric motor. The first exhaust air actuating member is connected to a first exhaust air actuating drive, and the second supply air actuating member is connected to a second air supply actuating drive. The second exhaust air actuating member is connected to a second exhaust air actuating drive. The actuating drives are preferably in the form of electric motors. The installation control unit associated with the first air supply bypass is connected to the first air supply actuating drive and to the second air supply actuating drive. The installation control unit associated with the first exhaust air bypass is connected to the first exhaust air actuating drive and to the second exhaust air actuating drive.

At least one air circulation unit is arranged in the air circulation zone and initially comprises an air circulation fan, which is driven by a motor, for feeding air from the air circulation zone into the working chamber. The air circulation unit also has a filter plenum, which is arranged downstream, before the air circulation fan; and an air filter, which is arranged downstream before the filter plenum and is adjacent to the working chamber. Two-point control is provided on the isolator and comprises a second exhaust air bypass which originates from the rear exhaust line section and opens into the filter plenum in an air circulation unit, and in which a third exhaust air actuating member, which is connected to a third exhaust air actuating drive, is installed. Additionally or alternatively to the second exhaust bypass, the two-point control comprises a second air supply bypass, which originates from the front supply line section and opens into the filter plenum of an air circulation unit, and in which a third air supply actuating member which is connected to a third air supply actuating drive is provided. The two-point control also includes a pressure sensor, which is arranged in the working chamber and is connected to a two-point regulator, as well as a compressed-air source, to which a compressed-air line which opens into the air circulation zone and is provided with a compressed-air actuating member is connected. The compressed-air actuating member is connected to a compressed-air actuating drive.

If a second exhaust air bypass is provided, the two-point regulator is connected to the third exhaust air actuating drive and to the compressed-air actuating drive. If a second supply air bypass is provided, the two-point regulator is connected to the third supply air actuating drive and to the compressed-air actuating drive. An air filter, which may have a filter plenum, is arranged downstream before the air supply fan in the air supply unit, in order to clean the air flowing out of the external surrounding area into the isolator. An air filter which may have a filter plenum is arranged downstream before the exhaust air fan in the exhaust air unit in order to clean the air which is emitted from the isolator into the external surrounding area. A decontamination system with an evaporator is provided in the internal area of the isolator.

### BRIEF DESCRIPTION OF THE ATTACHED DRAWINGS

In the drawings:

FIG. 1A—shows the basic hardware configuration of an isolator according to the prior art;

FIG. 1B—shows the air supply unit from FIG. 1A, illustrated enlarged;

FIG. 1C—shows the exhaust air unit from FIG. 1A, illustrated enlarged;

FIG. 1D—shows an air circulation unit from FIG. 1A, illustrated enlarged;

FIG. 1E—shows the access unit from FIG. 1A, illustrated enlarged;

FIG. 2A—shows the configuration of the isolator shown in FIG. 1A, with two-point control according to the prior art added to it;

FIG. 2B—shows an air circulation unit from FIG. 2A, illustrated enlarged;

FIG. 2C—shows the exhaust air unit from FIG. 2A, illustrated enlarged;

FIG. 2D—shows the compressed-air unit from FIG. 2A, illustrated enlarged;

FIG. 3A—shows the configuration shown in FIG. 2A, with the upgraded air supply unit according to the invention;

FIG. 3B—shows the air supply unit from FIG. 3A, illustrated enlarged;

FIG. 4A—shows the configuration shown in FIG. 2A, with a first variant of a first air supply bypass according to the invention added to it;

FIG. 4B—shows the air supply unit from FIG. 4A, illustrated enlarged;

FIG. 5A—shows the configuration shown in FIG. 4A, with a first variant of a first exhaust air bypass according to the invention added to it;

FIG. 5B—shows the exhaust air unit from FIG. 5A, illustrated enlarged;

FIG. 6A—shows the basic hardware configuration of an isolator with two air supply units and two exhaust air units as well as a first variant of first air supply and exhaust air bypasses associated with them;

FIG. 6B—shows an exhaust air unit from FIG. 6A, illustrated enlarged;

FIG. 6C—shows the enlarged detail of X1 from FIG. 6A;

FIG. 6D—shows the enlarged detail of X2 from FIG. 6A;

FIG. 7A—shows the configuration shown in FIG. 2A, with a second variant of a first air supply bypass according to the invention added to it;

FIG. 7B—shows the air supply unit from FIG. 7A, illustrated enlarged;

FIG. 8A—shows the configuration shown in FIG. 7A, with a second variant of a first exhaust air bypass according to the invention added to it;

FIG. 8B—shows the exhaust air unit from FIG. 8A, illustrated enlarged;

FIG. 9A—shows the basic hardware configuration of an isolator having two air supply units and two exhaust air units, as well as a second variant of first air supply and exhaust air bypasses associated with them; and

FIG. 9B—shows an exhaust air unit as shown in FIG. 9A, illustrated enlarged.

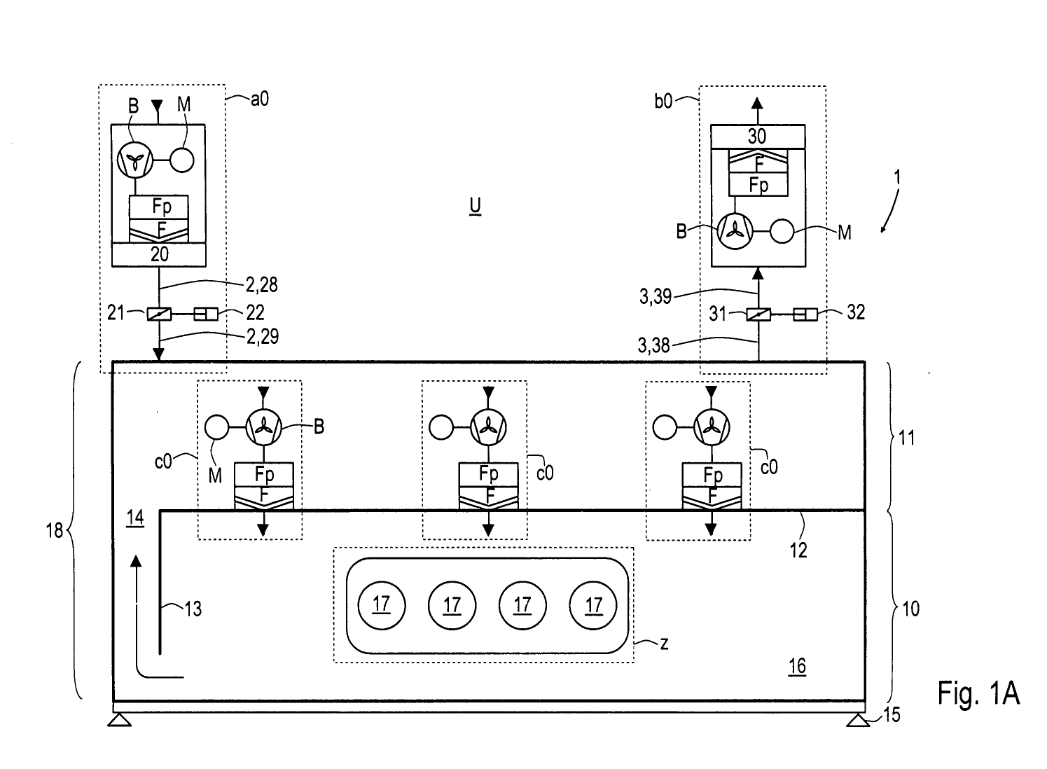

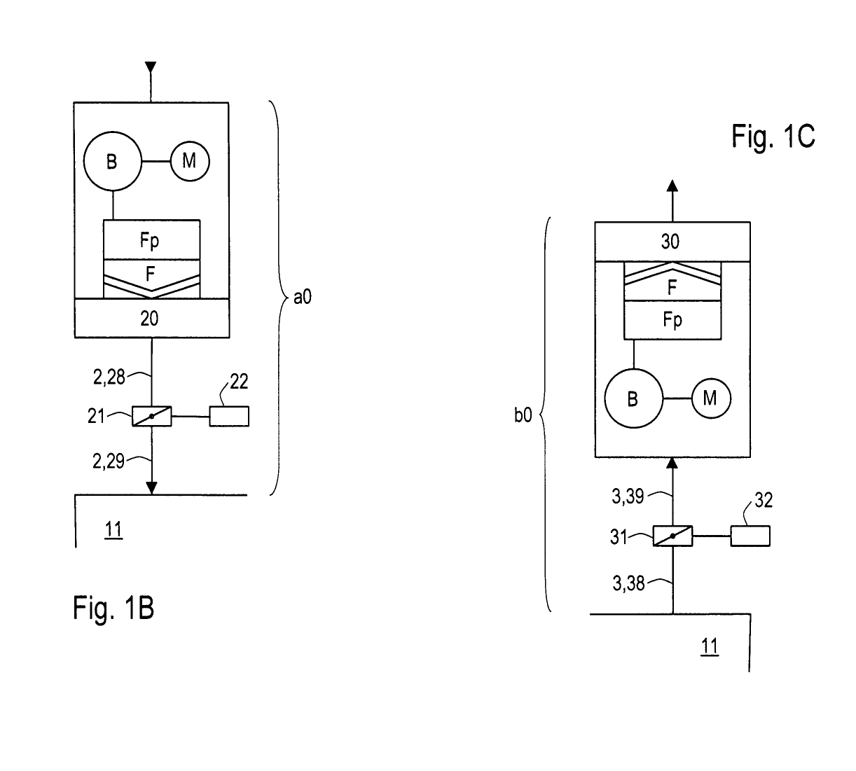

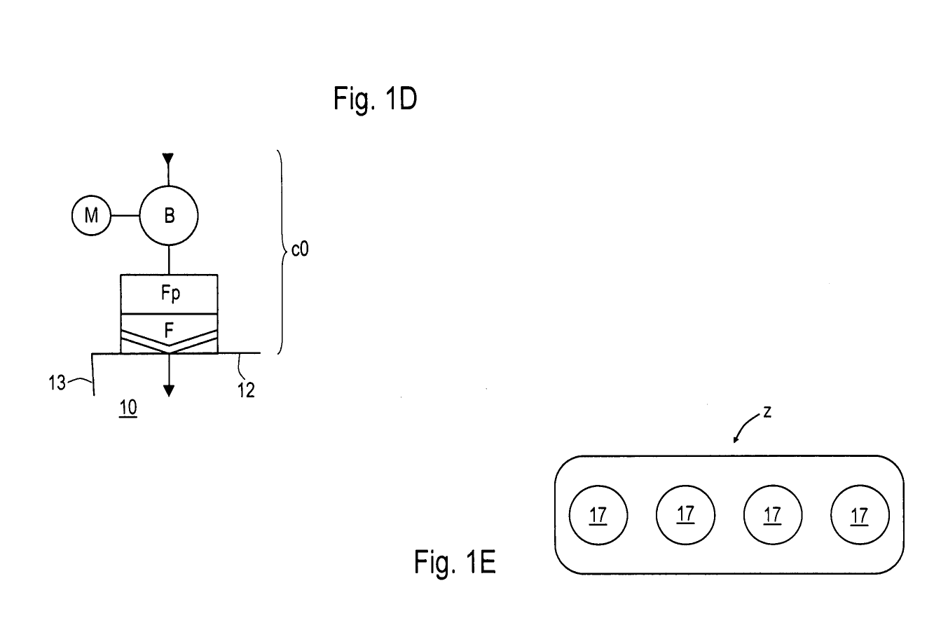

### EXEMPLARY EMBODIMENT

The following text contains a detailed description of preferred exemplary embodiments, on the basis of the attached drawings, relating to the hardware configuration and the method of operation of the pressure regulation according to the invention in an isolator, in some cases in a plurality of variants.

The following statement applies to all of the following description. Where the figures contain reference numbers for the purpose of drawing unambiguity, but these are not explained in the directly associated description text, then reference is made to their mention in the previous descriptions of the figures. In the interests of clarity, components are in general not identified repeatedly in subsequent figures, provided that it is possible to see unambiguously from the drawing that these are “recurring” components.

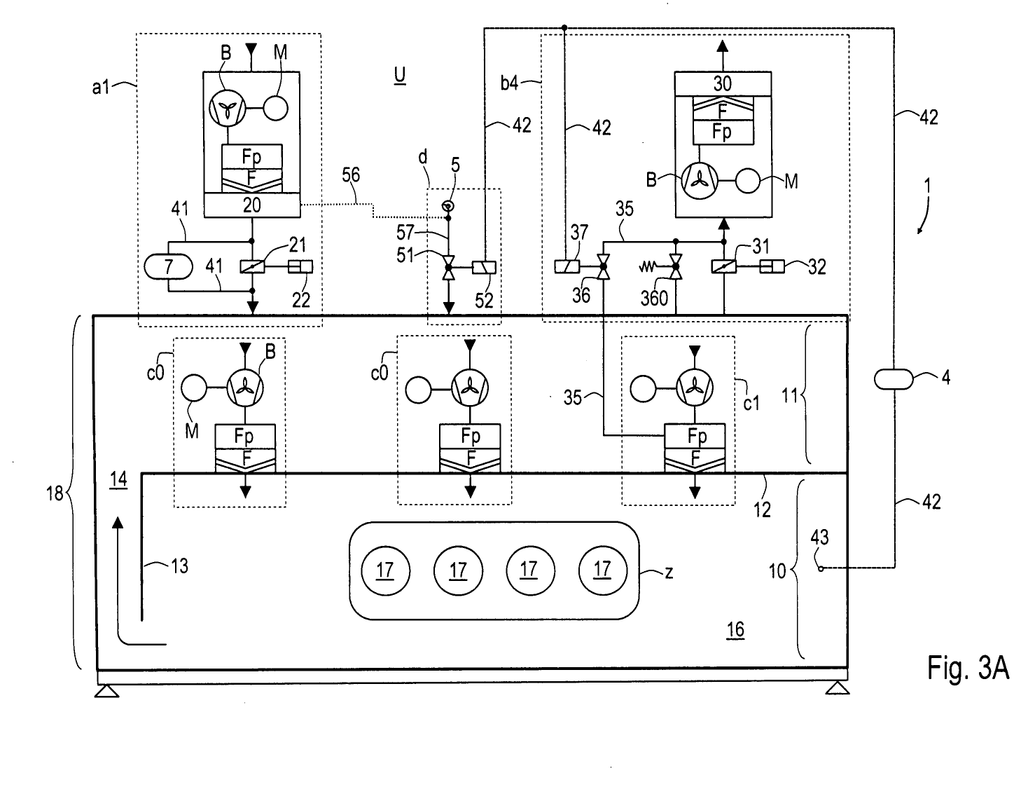

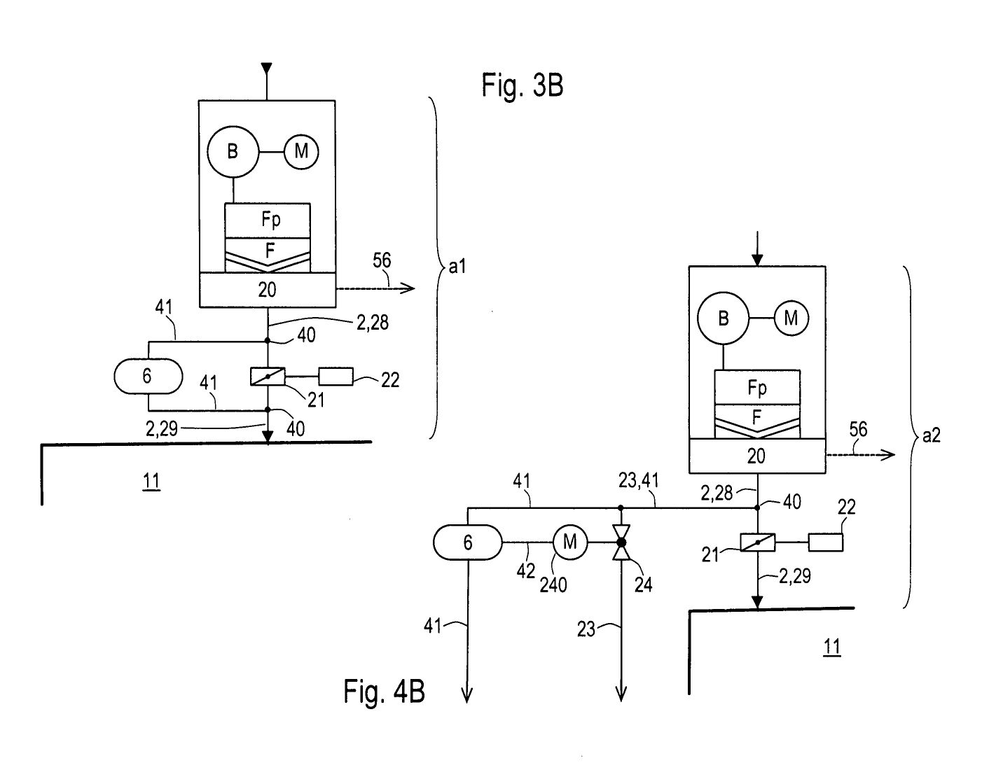

FIGS. 3A and 3B

It has been found that the pressure fluctuations which occur during opening and closing of the first air supply and exhaust air actuating members 21,31 can be avoided, or at least attenuated to such an extent that the pressure in the working chamber 10 is in each case kept within the safety range between the maximum permissible pressure Δpₘₐₓ and the minimum permissible pressure Δpₘᵢₙ with respect to the pressure in the external surrounding area U if the pressure on both sides of the first air supply and exhaust air actuating members 21,31 is brought to the same level before opening or closing of the first air supply or exhaust air actuating members 21,31.

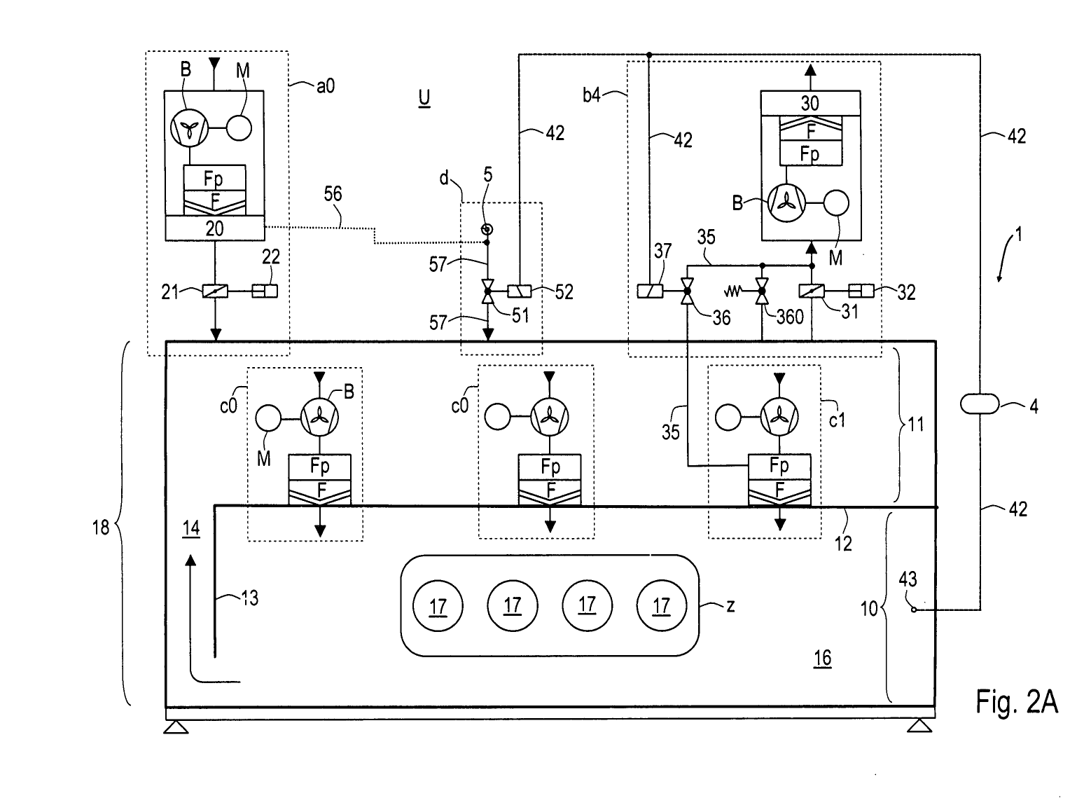

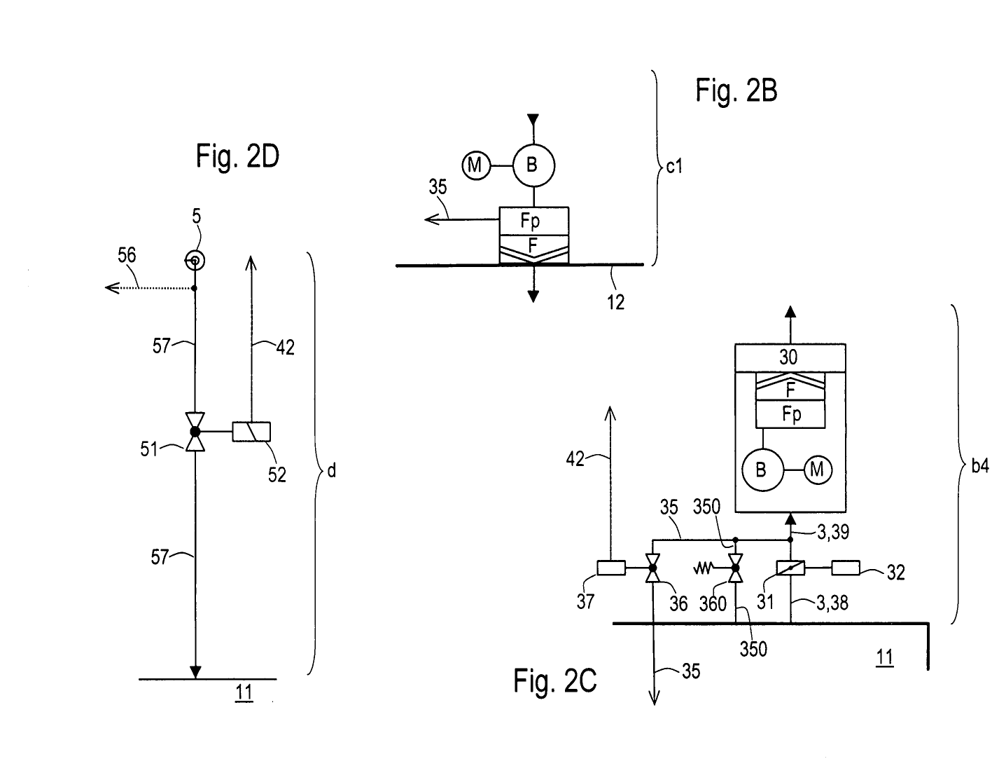

As a minimal solution in an extension to the previous hardware configuration shown in FIG. 2A, a differential pressure measurement is provided in the air supply unit a1, which is located outside the internal area 18, to be precise between a measurement point 40 in the front supply line section 28 of the supply line 2—before the first air supply actuating member 21—and a measurement point 40 in the rear supply line section 29—after the first air supply actuating member 21. The pressure signals which are tapped off at the measurement points 40 are transmitted via the respective measurement line 41 to a differential pressure meter 7 which, in this configuration, is installed as a separate component but could advantageously be integrated in an installation control unit, which is not shown here. The installation control unit would act to an adequate extent with regard to the determined differential pressure and after signal evaluation—manually or automatically—on the two-point control in the compressed-air unit d and in the exhaust air unit b4, with the latter likewise being located outside the internal area 18.

If the pressure on the chamber side, that is to say in the rear supply line section 29, is higher than on the outside, that is to say in the front supply line section 28, then the third exhaust air actuating drive 37 is driven to open the third exhaust air actuating member 36, in order that air flows out of the internal area 18 via the second exhaust air bypass 35, and in consequence the pressure therefore falls, until the pressures at the two measurement points 40 are equal, that is to say on the chamber side and on the outside. If the air is intended to be carried away from the internal area 18 with an increased throughput, the fan B in the exhaust air unit b4 is also driven.

If, on the other hand, the pressure is determined to be lower on the chamber side than on the outside, the compressed-air actuating drive 52 is driven in order to open the compressed-air actuating member 51, in response to which air is fed into the air circulation zone 11 from the compressed-air source 5 via the compressed-air line 57 until the pressure difference between the chamber side and the outside has been cancelled out. Air from the external surrounding area U may be added to the compressed air. For this purpose, the fan B in the air supply unit a1 is started up, and the air is fed from the external surrounding area U via the filter plenum Fp, the filter F and the outlet flow area 20 into the adjustment line 56, and from there into the compressed-air line 57, from where it is passed together with the air from the compressed-air source 5 into the air circulation zone 11. Finally, it is also possible to draw the amount of air to be supplied to the internal area 18 in order to produce the same pressure level on the chamber side as on the outside of the air supply actuating member 21 solely from the external surrounding area U, and to dispense with the supply of compressed air from the source 5. Once the same pressures have been produced between the chamber side and the outside, the isolator 1 can be switched to a different operating phase by operation of the first air supply and/or exhaust air actuating members 21,31—for example from the fully closed state to the entirely open position—without initiating the previous critical pressure surges. This process is referred to for short in the following text as “pressure-surge-free operation” of the first actuating members 21,31.

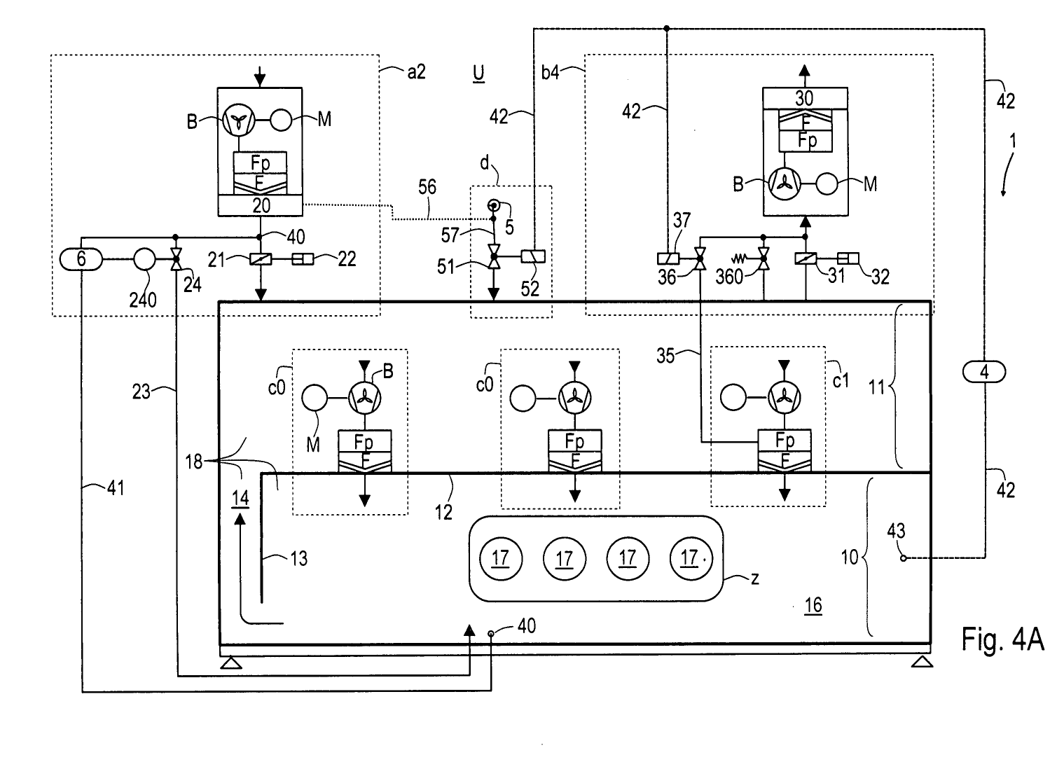

FIGS. 4A and 4B

In addition to the arrangement shown in FIG. 2A, the air supply unit a2 has a first variant of a first air supply bypass 23 according to the invention, as well as an associated device for differential pressure regulation. This first air supply bypass 23 branches off before the first air supply actuating member 21 from the front supply line section 28 of the supply line 2, and leads into the lower area of the working chamber 10. A second air supply actuating member 24 is located in the first air supply bypass 23 and has an associated second air supply actuating drive 240, preferably an electric motor M. The second air supply actuating member 24 advantageously has a large nominal width and thus causes only a small flow resistance. The device for differential-pressure regulation first of all comprises the differential-pressure sensor, which is advantageously an integral component of the installation control unit 6 and receives signals from two measurement points 40. One of the measurement points 40 is arranged in the immediate vicinity of the opening of the first supply line bypass 23 into the working chamber 10, while the other measurement point 40 is located where the first air supply bypass 23 branches off from the front supply line section 28. Measurement lines 41 extend from both measurement points 40 to the differential-pressure sensor in the installation control unit 6, which is connected via a signal line 42 to the second air supply actuating drive 240. In the complete circuitry, the installation control unit 6 is connected to the fan B and to the first air supply actuating drive 22 in the air supply unit a2.

The arrangement for pressure-surge-free operation of the first air supply actuating member 21 operates as follows: before intended opening or closing of the first air supply actuating member 21, the installation control unit 6 acts as a function of the differential pressure as determined by the differential-pressure sensor first of all on the second air supply actuating drive 240 and the fan B in the air supply unit a2, with the fan B being started up slowly and opening the second air supply actuating member 24, and with a comparatively small amount of air being passed through the first air supply bypass 23 into the working chamber 10. After the fan B, the air which is fed in enters the filter plenum Fp, from where the air passes through the air filter F into the outlet flow area 20, from where it flows via the front supply line section 28 of the supply line 2 into the first air supply bypass 23.

An equivalent amount of air to that supplied to the working chamber 10 is emitted via the second exhaust air bypass 35 into the external surrounding area U. The outlet flow from the filter plenum Fp in the air circulation unit c1 takes place via the second exhaust air bypass 35, the third exhaust air actuating member 36, the rear exhaust line section 39, via the fan B, into the filter plenum Fp, from where the air flows through the air filter F into the outlet flow area 30, and from the latter finally into the external surrounding area U. The air supply unit a2 together with the first air supply actuating member 21, as well as the exhaust air unit b4 together with the first exhaust air actuating member 31, are arranged outside the internal area 18.

Since, with its large nominal width, the second air supply actuating member 24 causes only a small flow resistance when the air throughput through the entire first air supply bypass 23 is small, virtually no pressure is dropped over the extent of the first air supply bypass 23—the pressure in the working chamber 10 and that upstream before the first air supply actuating member 21 are at least approximately the same—so that this results in a differential pressure of, in principle, zero on both sides of the first air supply actuating member 21 as well. The installation control unit 6 detects the disappearance of the pressure difference, and drives the first air supply actuating drive 22, which operates the first air supply actuating member 21, with this switching process no longer causing any pressure surges in the working chamber 10.

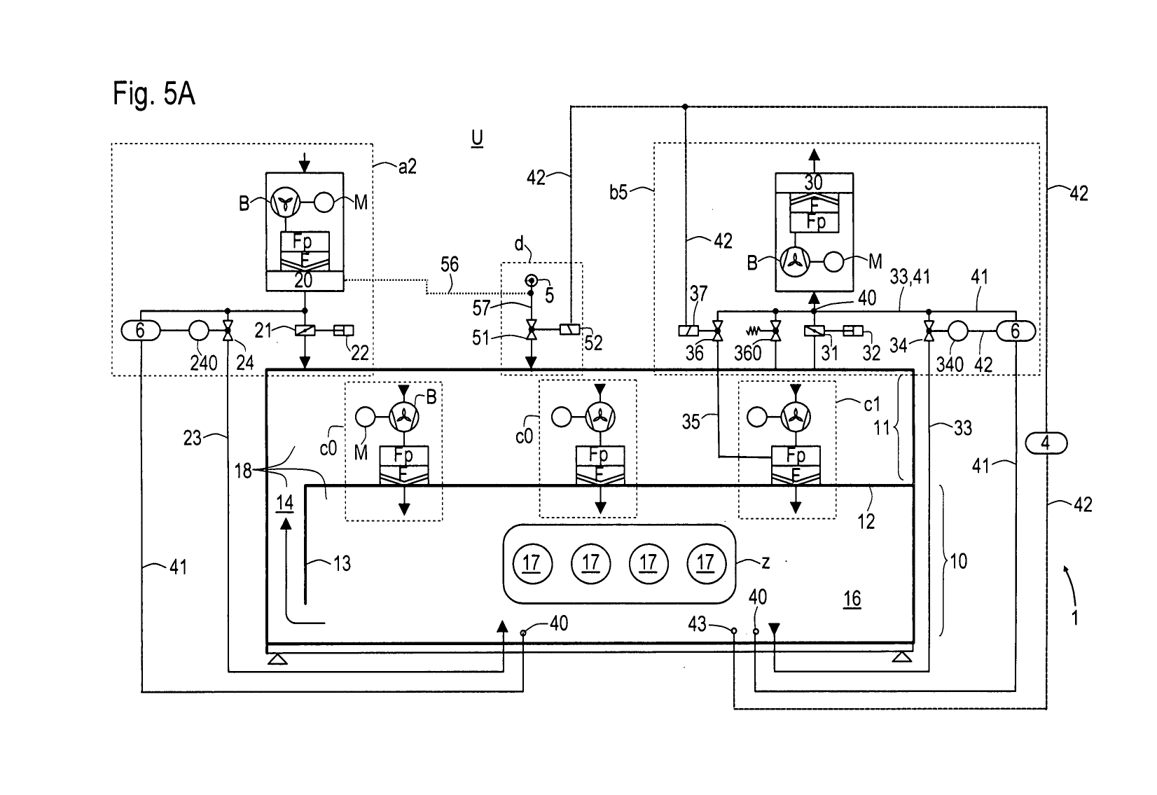

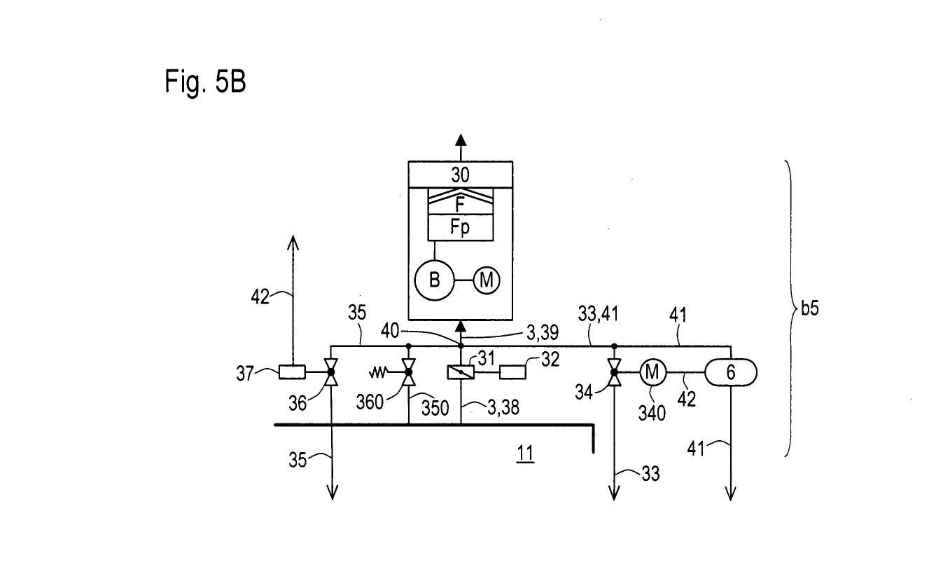

FIGS. 5A and 5B

As an improvement to the arrangement shown in FIG. 4A, the exhaust air unit b5 which is arranged outside the internal area 18 now has added to it a first variant of a first exhaust air bypass 33 according to the invention, as well as an associated device for differential-pressure regulation.

This first exhaust air bypass 33 branches off from the rear exhaust line section 39 of the exhaust line 3 behind the first exhaust air actuating member 31, and leads into the lower area of the working chamber 10. A second exhaust air actuating member 34 is provided in the first exhaust air bypass 33 and is connected to a second exhaust air actuating drive 340, preferably an electric motor M. The second exhaust air actuating member 34 should have a large nominal width, and should thus cause only a small flow resistance. The device for differential-pressure regulation once again comprises a differential-pressure sensor, which is advantageously contained in the installation control unit 6 and receives data from two measurement points 40, one of which is located close to the opening of the first exhaust air bypass 33 into the working chamber 10, while the other is positioned where the first exhaust air bypass 33 emerges from the rear exhaust line section 39. Measurement lines 41 extend from the two measurement points 40 to the differential-pressure sensor in the installation control unit 6, which connects a signal line 42 to the second exhaust air actuating drive 340. In the complete circuitry, the installation control unit 6 is connected to the fan B and to the exhaust air actuating drive 32 in the exhaust air unit b5.

The arrangement for pressure-surge-free operation of the first exhaust air actuating member 31 operates as follows: before the planned opening or closing of the first exhaust air actuating member 31, and as a reaction to the differential pressure detected by the differential-pressure sensor, the installation control unit 6 first of all acts on the second exhaust air actuating drive 340 and the fan B in the exhaust air unit b5, with the fan B being started up slowly and opening the second exhaust air actuating member 34, and with a relatively small amount of air being fed from the working chamber 10 via the first exhaust air bypass 33 into the external surrounding area U. This air which is drawn out of the internal area 18 passes from the working chamber 10 into the first exhaust air bypass 33, and flows via the second exhaust air actuating member 34 into the rear exhaust line section 39 of the exhaust line 3, and from there onwards to the fan B, which feeds the air into the filter plenum Fp, and through the air filter F into the exhaust flow area 30, and finally into the external surrounding area U. An amount of air corresponding to that drawn from the working chamber 10 is fed via the compressed-air line 57 and the compressed-air actuating member 51 from the compressed-air source 5 into the air circulation zone 11.

Since the second exhaust air actuating member 34 with its large nominal width causes only a small flow resistance when the air throughput through the entire first exhaust air bypass 33 is small, there is virtually no pressure drop across the first exhaust air bypass 33—the pressure in the working chamber 10 and that up-stream before the first exhaust air actuating member 31 are virtually the same—so that a differential pressure of, in principle, zero is also produced on both sides of the first exhaust air actuating member 31. Once the installation control unit 6 has detected the raised pressure difference, it acts on the first exhaust air actuating drive 32, which actuates the first exhaust air actuating member 31, without producing any pressure surges in the working chamber 10 in the process.

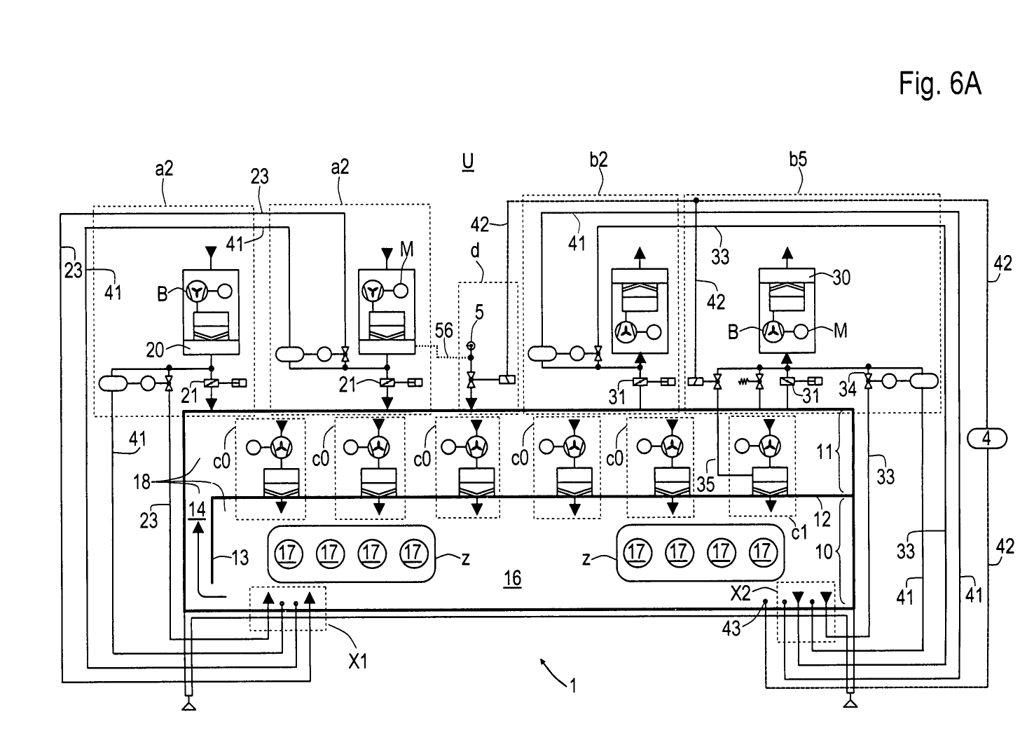

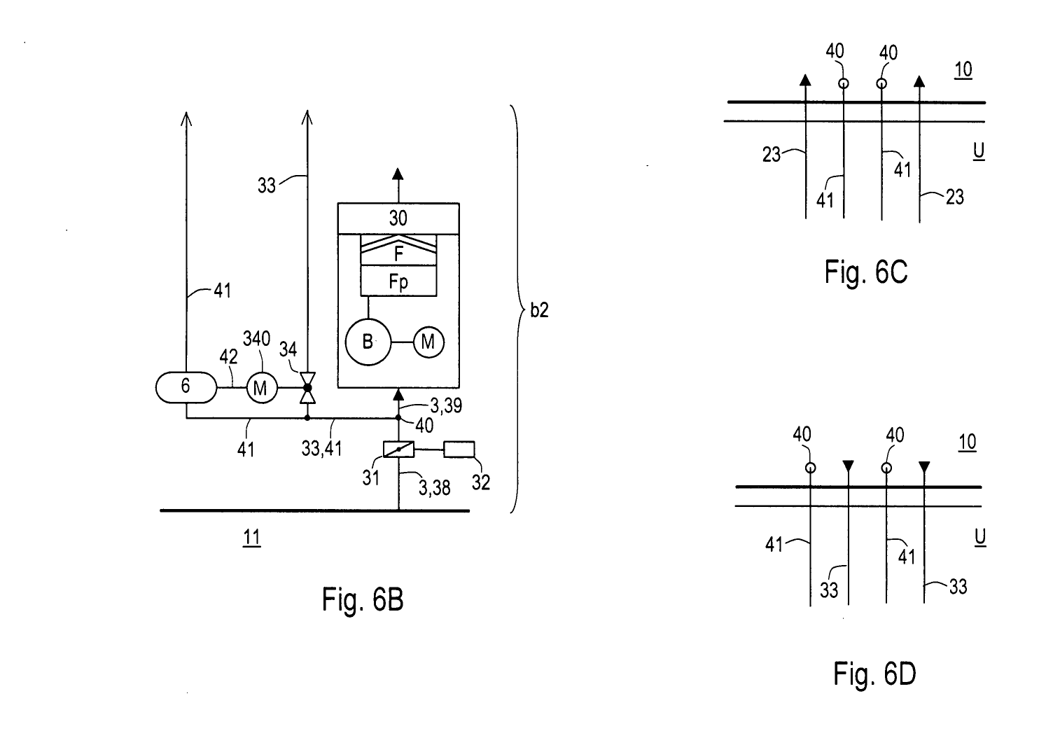

FIGS. 6A to 6D

This sequence of figures shows an isolator 1 with a working chamber 10 of relatively large size with hardware equipment which in principle duplicates that shown in FIG. 5A. A further air supply unit a2 and an exhaust air unit b2 are added, with the latter being equipped analogously to the first air supply bypass 23 in the air supply unit a2, with regard to its first exhaust air bypass 33. The isolator 1 now has two air supply units a2 as well as two exhaust air units b2,b5, which are each located outside the internal area 18, and a first variant of a first air supply bypass 23 and a first variant of a first exhaust air bypass 33. In comparison to the exhaust air unit b5, the exhaust air unit b2 has neither a second exhaust air bypass 35 nor a safety line 350 with a safety valve 360 arranged in it.

The openings of the two first air supply bypasses 23 into the working chamber 10, together with the measurement points 40 which are provided at the end of the measurement lines 41, are preferably positioned in the lower area of the working chamber 10, close to the inlet into the return air channel 14. The outlets from the two first exhaust air bypasses 33 from the working chamber 10 together with the measurement points 40 which are provided at the end of the measurement lines 41 are preferably installed in the lower area of the working chamber 10, as far as possible from the openings of the first air supply bypasses 23.

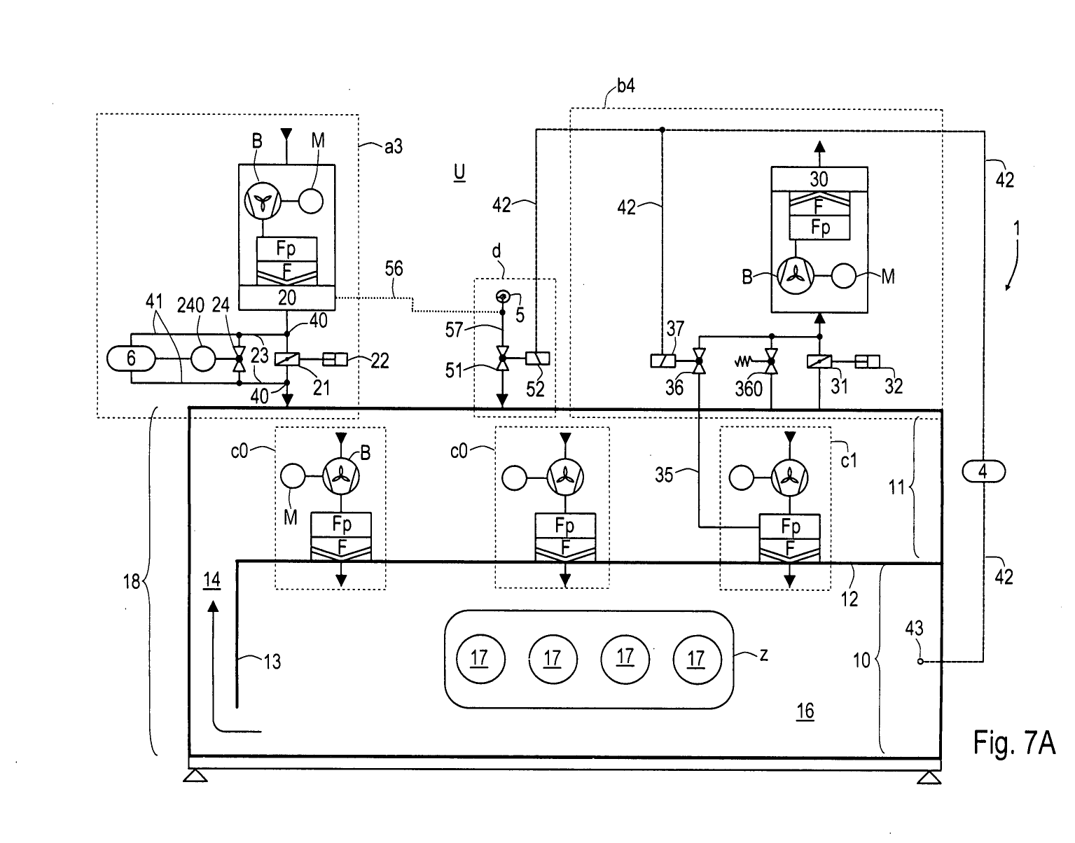

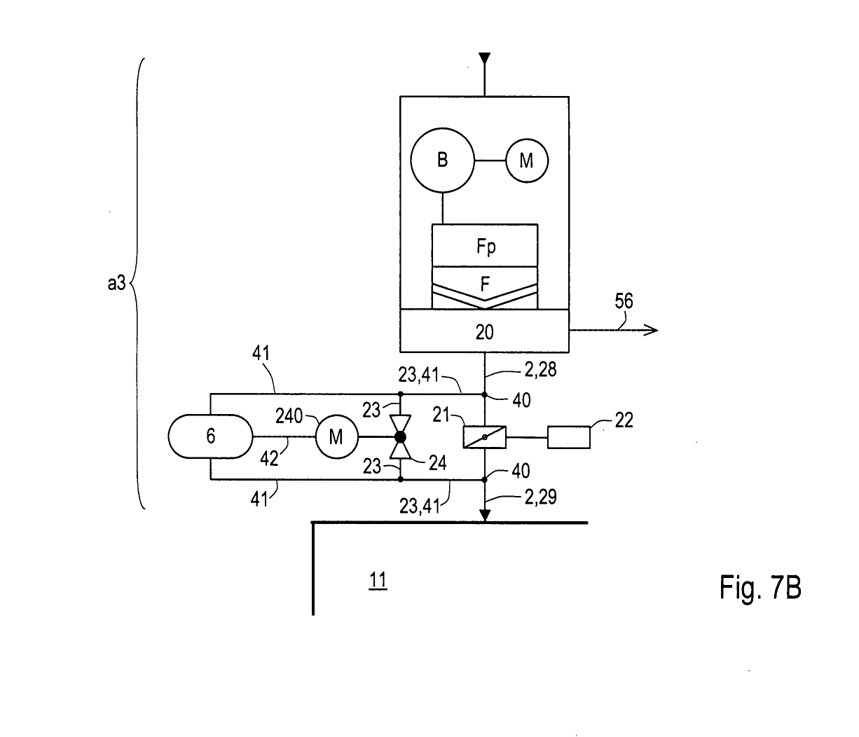

FIGS. 7A and 7B

As an improvement to the arrangement shown in FIG. 2A, the air supply unit a3 has a second variant of a first air supply bypass 23 according to the invention, as well as an associated device for differential-pressure regulation. This first air supply bypass 23 is tapped off before the first air supply actuating member 21 from the front supply line section 28 of the supply line 2, and, on the chamber side, opens directly behind the first air supply actuating member 21 into the rear supply line section 29.

A second air supply actuating member 24 is located in the first air supply bypass 23, and is connected to a second air supply actuating drive 240, preferably an electric motor M. The second air supply actuating member 24 advantageously has a large nominal width, and thus generates only a small flow resistance. The device for differential-pressure regulation first of all contains the differential-pressure sensor, which is preferably provided in the installation control unit 6 and receives data from the two measurement points 40, with one of the measurement points 40 being arranged in the opening of the first air supply bypass 23 into the rear supply line section 29, while the other measurement point 40 is located where the first air supply bypass 23 is tapped off from the front supply line section 28. Measurement lines 41 extend from both measurement points 40 to the differential-pressure sensor in the installation control unit 6, with the latter being connected by a signal line 42 to the second air supply actuating drive 240. In the complete equipment, the installation control unit 6 is coupled to the fan B and to the first air supply actuating drive 22 in the air supply unit a3.

The arrangement for pressure-surge-free operation of the first air supply actuating member 21 operates as described in the following text: before planned opening or closing of the first air supply actuating member 21, and in reaction to the differential pressure determined by the differential-pressure sensor, the installation control unit 6 first of all drives the second air supply actuating drive 240 and the fan B in the air supply unit a3, with the fan B being started up slowly and opening the second air supply actuating member 24, with a relatively small amount of air being passed via the first air supply bypass 23. This supplied air flows from the fan B into the filter plenum Fp, from where the air passes through the air filter F into the outlet flow area 20, from which it passes via the front supply line section 28 of the supply line 2, the first air supply bypass 23 and the rear supply line section 29 into the air circulation zone 11. An amount of air equivalent to that supplied to the air circulation zone 11 is emitted via the second exhaust air bypass 35 into the external surrounding area U. The exhaust flow takes place from the filter plenum Fp in the air circulation unit c1 via the second exhaust air bypass 35, the third exhaust air actuating member 36, the rear exhaust line section 39, via the fan B, into the filter plenum Fp, from where the air flows through the air filter F into the exhaust flow area 30, and from the latter finally into the external area U. The air supply unit a3 as well as the exhaust air unit b4 are located, unmodified, outside the internal area 18.

Since the second air supply actuating member 24 with its large nominal width produces only a small flow resistance when the air throughput via the entire first air supply bypass 23 is small, there is virtually no pressure drop across the first air supply bypass 23, so that the differential pressure on both sides of the first air supply actuating member 21 is in principle zero. The installation control unit 6 detects the cancellation of the pressure difference and acts on the first air supply actuating drive 22, which activates the first air supply actuating member 21, with this switching process now no longer causing any critical pressure fluctuations in the working chamber 10.

The second variant of the first air supply bypass 23 ensures that, when the installation control unit 6 determines that the pressure difference is zero, the pressures on the chamber side and on the outside directly adjacent to the first air supply actuating member 21 are the same. With the first variant of the first air supply bypass 23, despite the installation control unit 6 detecting a pressure difference of zero, a residual pressure difference could, however, still remain on both sides directly adjacent to the first air supply actuating member 21, since one of the measurement points 40 is arranged at a greater distance from the first air supply actuating member 21 in the working chamber 10. Since the pressure surges are reduced to a minimum when the pressure is exactly the same on the chamber side and on the outside in the vicinity of the first air supply actuating member 21, and before it is operated, the second variant of the first air supply bypass 23 thus makes it possible to achieve the object even more precisely than the first variant of the first air supply bypass 23.

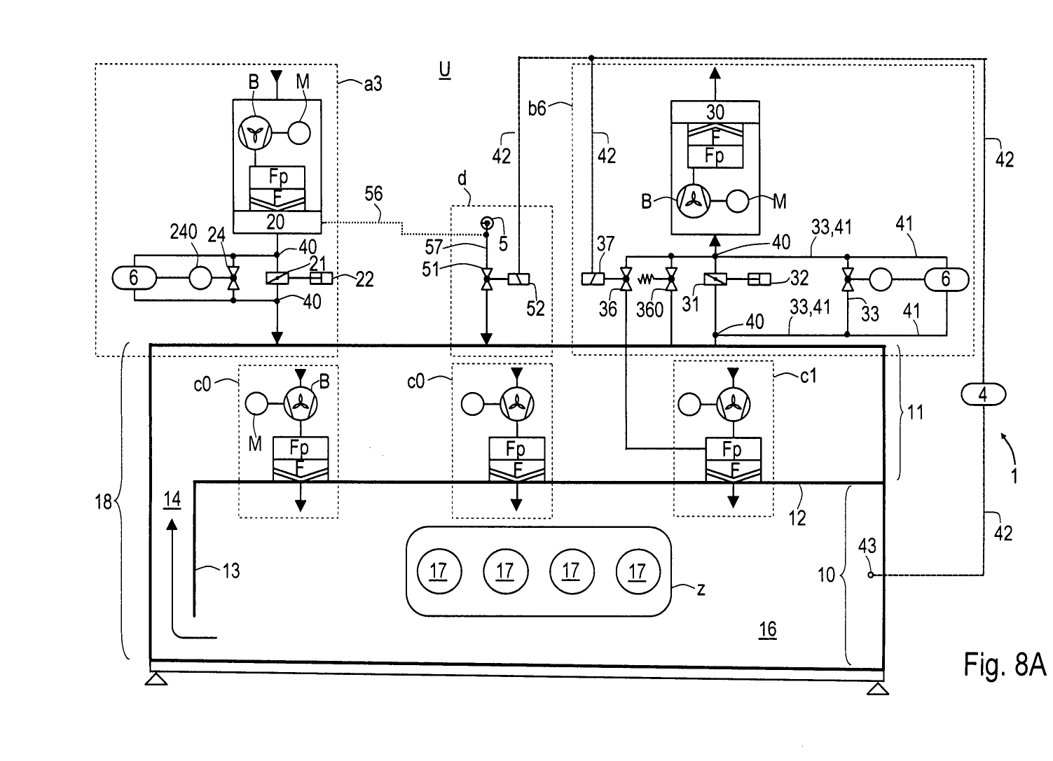

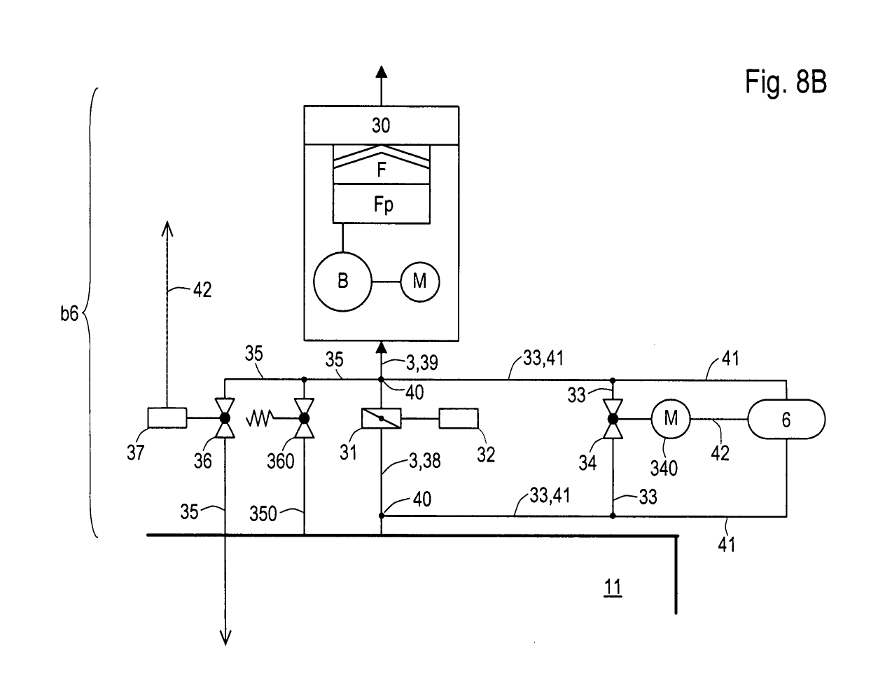

FIGS. 8A and 8B

In a further improvement to the arrangement shown in FIG. 7A, the exhaust air unit b6 is now equipped with a second variant of a first exhaust air bypass 33 according to the invention, as well as an associated device for the differential-pressure regulation. The air supply unit a3 as well as the exhaust air unit b6 are located outside the internal area 18, as before.

This first exhaust air bypass 33 emerges downstream from the rear exhaust line section 39 of the line 3 before the first exhaust air actuating member 31, and opens into the front exhaust line section 38 in the vicinity of the first exhaust air actuating member 31, on its chamber side. A second exhaust air actuating member 34, which is connected to a second exhaust air actuating drive 340, is installed in the first exhaust air bypass 33, with the second exhaust air actuating drive 340 preferably being an electric motor M. It has been found to be advantageous to use a second exhaust air actuating member 34 with a large nominal width, so that the flow resistance is only small. The device for differential-pressure regulation once again includes a differential-pressure sensor which is advantageously contained in the installation control unit 6 and receives data from two measurement points 40, one of which is located in the vicinity of the opening of the first exhaust air bypass 33 into the rear exhaust line section 39, while the other measurement point 40 is positioned at the output branch of the first exhaust air bypass 33 in the front exhaust line section 38. Two measurement lines 41 run from the two measurement points 40 to the differential-pressure sensor in the installation control unit 6, which is connected via a signal line 42 to the second exhaust air actuating drive 340. In the complete circuitry, the installation control unit 6 is connected to the fan B and to the exhaust air actuating drive 32 in the exhaust air unit b6.

The arrangement for pressure-surge-free operation of the first exhaust air actuating member 31 operates as follows: before the opening or closing of the first exhaust air actuating member 31, and as a function of the differential pressure determined by the differential-pressure sensor, the installation control unit 6 first of all drives the second exhaust air actuating drive 340 and the fan B in the exhaust air unit b6, with the fan B being started up at a moderate rate and opening the second exhaust air actuating member 34, and with a relatively small amount of air being passed from the front exhaust line section 38 of the exhaust line 3 via the first exhaust air bypass 33 into the external surrounding area U. This air which is taken from the front exhaust line section 38 flows out of the air circulation zone 11 back into the front exhaust line section 38, from where it passes via the first exhaust air bypass 33 and the second exhaust air actuating member 34 into the rear exhaust line section 39 of the exhaust line 3, and onwards to the fan B, which passes the air into the filter plenum Fp and through the air filter F into the outlet flow area 30, and finally into the external surrounding area U. The amount of air taken from the air circulation zone 11 is replaced by air which is taken from the compressed-air source 5 via the compressed-air line 57 and the compressed-air actuating member 51, and is introduced into the air circulation zone 11.

Since the second exhaust air actuating member 34 with it large nominal width causes only a small flow resistance over the entire first exhaust air bypass 33 if the air throughput is small, there is virtually no pressure drop across the first exhaust air bypass 33, so that the differential pressure between the two sides of the first exhaust air actuating member 31 is in principle zero. Once the installation control unit 6 has detected the elimination of the pressure difference, the exhaust air actuating drive 32 is driven and operates the first exhaust air actuating member 31 without generating any significant pressure surges in the working chamber 10 in the process.

The second variant of the first exhaust air bypass 33 ensures that, when the installation control unit 6 determines a pressure difference of zero, the pressure directly adjacent to the first exhaust air actuating member 31 is the same on both of its sides. In contrast, in the case of the first variant of the first exhaust air bypass 33, it is impossible to preclude the possibility of the pressures on the two sides of the first exhaust air actuating member 31 being different in the immediate vicinity of it, despite the pressure-difference meter determining a pressure difference of zero, since one of the measurement points 40 is arranged at a distance from the first exhaust air actuating member 31 in the working chamber 10. Since the pressure fluctuations are minimal when the pressure is the same on both sides in the vicinity of the first exhaust air actuating member 31, before it is operated, the second variant of the first exhaust air bypass 33 may thus have a certain advantage over the first variant of the first exhaust air bypass 33.

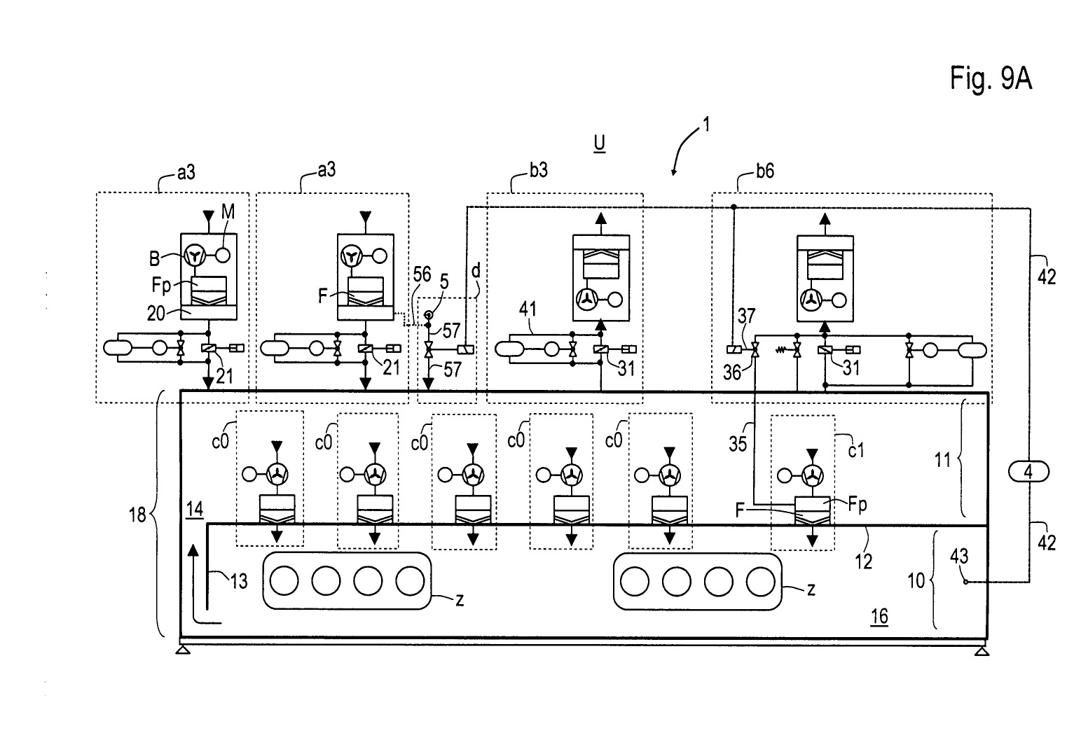

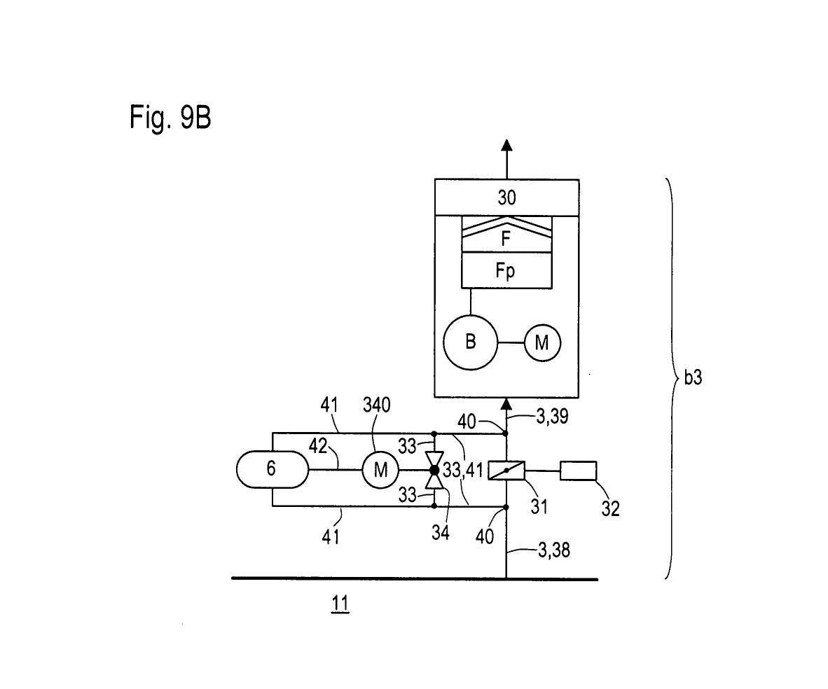

FIGS. 9A and 9B

This sequence of figures shows an isolator 1 with a working chamber 10 of relatively large size, with a hardware configuration which in principle duplicates that shown in FIG. 8A.

An additional air supply unit a3 and an exhaust air unit b3 have been added, with the latter being equipped identically to the first air supply bypass 23 in the air supply unit a3, in terms of its first exhaust air bypass 33—apart from the inverted flow direction. The isolator 1 now has two air supply units a3 as well as two exhaust air units b3,b6, which are each arranged outside the internal area 18 and are equipped with a second variant of a first air supply bypass 23 and, respectively, with a second variant of a first exhaust air bypass 33. In contrast to the exhaust air unit b6, the exhaust air unit b3 has neither a second exhaust air bypass 35 nor a safety line 350 with a safety valve 360 arranged in it.

1. A method for pressure regulation in a working chamber (10), which is shielded from the external surrounding area (U), in an isolator (1) when the isolator (1) is being opened or closed with respect to the external surrounding area (U), in which
a) the working chamber (10) has an access for introduction and removal of the product to be handled,
b) the isolator (1) has an air circulation zone (11) from which the working chamber (10) is supplied with clean air, air is fed back into the air circulation zone (11) from the working chamber (10) via a return air channel (14), and the working chamber (10), air circulation zone (11) and return air channel (14) together form an internal area (18);
c) an air supply unit (a0,a1,a2,a3) is provided on the isolator (1) and has an air supply fan (B) and a first air supply actuating member (21) which can be shut off and is arranged between the air supply fan (B) and the internal area (18);
d) an exhaust air unit (b0,b2,b3,b4,b5,b6) is provided on the isolator (1) and has an exhaust air fan (B) and a first exhaust air actuating member (31) which can be shut off and is arranged between the exhaust air fan (B) and the internal area (18), characterized in that
e) the phase change is carried out as a switching process at the first air supply actuating member (21) and first exhaust air actuating member (31) from the closed state to the open state, or vice versa, in the following steps:
ea) measurement of the differential pressure on both sides of the first air supply actuating member (21) and/or on both sides of the first exhaust air actuating member (31);
eb) production of at least in principle equal pressures on both sides of the first air supply actuating member (21) and/or on both sides of the first exhaust air actuating member (31); and
ec) carrying out the switching process at the first air supply actuating member (21) and first exhaust air actuating member (31).

2. The method as claimed in claim 1, characterized in that, when the first air supply actuating member (21) and the first exhaust air actuating member (31) are completely closed, the internal area (18) of the isolator (1) is in each case opened with respect to the external surrounding area (U), producing an equalizing flow with as little flow resistance as possible, on the side of the air supply unit (a1,a2,a3) and on the side of the exhaust air unit (b2,b3,b4,b5,b6) in order to produce at least in principle the same pressure on both sides of the first air supply actuating member (21) and/or on both sides of the first exhaust air actuating member (31).

3. The method as claimed in at least one of claims 1 and 2, characterized in that
a) a first air supply bypass (23) which bypasses the first air supply actuating member (21), as well as a second air supply actuating member (24) which is arranged in the first air supply bypass (23) are used to produce at least in principle the same pressure on both sides of the first air supply actuating member (21); and
b) a first exhaust air bypass (33) which bypasses the first exhaust air actuating member (31), as well as a second exhaust air actuating member (34) which is arranged in the first exhaust air bypass (33) are used in order to produce at least in principle the same pressure on both sides of the first exhaust air actuating member (31); in which case
c) after the determination of the differential pressure on both sides of the first air supply actuating member (21), the second air supply actuating member (24) is opened wide, and the air supply fan (B) is started up with the feed power slowly rising in order to produce the equalizing flow, which is generated from the air supply unit (a2,a3) and is directed into the internal area (18), with as little flow resistance as possible through the first air supply bypass (23); and/or
d) after the determination of the differential pressure on both sides of the first exhaust air actuating member (31), the second exhaust air actuating member (34) is opened wide and the exhaust air fan (B) is started up with the feed power slowly rising in order to produce the equalizing flow, which is sucked out of the internal area (18) and is directed into the exhaust air unit (b2,b3,b4,b5,b6), with as little flow resistance as possible through the first exhaust air bypass (33); and
e) after reaching at least in principle the same pressures on both sides of the first air supply actuating member (21) and/or of the first exhaust air actuating member (31), the switching process is carried out at the first air supply actuating member (21) and the first exhaust air actuating member (31).

4. The method as claimed in claim 3, characterized in that
a) the differential pressure which is measured on both sides of the first air supply actuating member (21) is transmitted to an installation control unit (6) which is associated with the first air supply bypass (23);
b) in order to produce the equalizing flow, as a function of the processed differential pressure, the installation control unit (6):
ba) drives a second air supply actuating drive (240) which operates the second air supply actuating member (24); and
bb) starts up the air supply fan (B); and
c) after reaching at least in principle the same pressures on both sides of the first air supply actuating member (21), the installation control unit (6) drives a first air supply actuating drive (22) which carries out the switching process at the first air supply actuating member (21); and
d) the differential pressure which is measured on both sides of the first exhaust air actuating member (31) is transmitted to an installation control unit (6) which is associated with the first exhaust air bypass (33);
e) in order to produce the equalizing flow, as a function of the processed differential pressure, the installation control unit (6):
ea) drives a second exhaust air actuating drive (340), which operates the second exhaust air actuating member (34); and
eb) starts up the exhaust air fan (B); and
f) after reaching at least in principle the same pressures on both sides of the first exhaust air actuating member (31), the installation control unit (6) drives a first exhaust air actuating drive (32), which carries out the switching process at the first exhaust air actuating member (31).

5. The method as claimed in at least one of claims 1 to 4, characterized in that, with regard to the compensation of the equalizing flow
a) a corresponding volume to the amount of air fed from the air supply unit (a2,a3) into the internal area (18) is dissipated from the internal area (18) via the exhaust air unit (b2,b3,b4,b5,b6) into the external surrounding area (U), with a two-point regulator (4) regulating the air passing through the exhaust air unit (b2,b3,b4,b5,b6) as a function of the pressure in the internal area (18);
b) a corresponding volume to the amount of air sucked out of the internal area (18) by the exhaust air unit (b2,b3,b4,b5,b6) is supplied to the internal area (18) via the air supply unit (a2,a3) or a compressed-air unit (d), with a two-point regulator (4) controlling the air passing through the air supply unit (a2,a3) as a function of the pressure in the internal area (18).

6. An apparatus for pressure regulation in an isolator (1) having:
a) a working chamber (10) which is shielded from the external surrounding area (U) and has an access for introduction and removal of the product to be handled;
b) an air circulation zone (11) from which clean air is supplied to the working chamber (10), in which air is fed back into the air circulation zone (11) from the working chamber (10) via a return air channel (14), and the working chamber (10), air circulation zone (11) and return air channel (14) together form an internal area (18);
c) an air supply unit (a0,a1,a2,a3) which has an air supply fan (B) and a first air supply actuating member (21) which can be shut off and is arranged between the air supply fan (B) and the internal area (18);
d) an exhaust air unit (b2,b3,b4,b5,b6), which has an exhaust air fan (B) and a first exhaust air actuating member (31) which can be shut off and is arranged between the exhaust air fan (B) and the internal area (18), characterized in that
e) means are provided for measurement of the differential pressure on both sides of the first air supply actuating member (21), and means (23,24,B) are provided for production of at least in principle the same pressure on both sides of the first air supply actuating member (21); and/or
f) means are provided for measurement of the differential pressure on both sides of the first exhaust air actuating member (31), and means (33,34,B) are provided for production of at least in principle the same pressure on both sides of the first exhaust air actuating member (31).

7. The apparatus as claimed in claim 6, characterized in that
a) the means (23,24,B) for production of at least in principle the same pressure on both sides of the first air supply actuating member (21) comprise a first air supply bypass (23) which bypasses the first air supply actuating member (21) and has a second air supply actuating member (24); and
b) the means (33,34,B) for production of at least in principle the same pressure on both sides of the first exhaust air actuating member (31) comprise a first exhaust air bypass (33) which bypasses the first exhaust air actuating member (31) and has a second exhaust air actuating member (34); in which case
c) the second air supply actuating member (24) and the second exhaust air actuating member (34) are preferably variably adjustable between being completely shut off and being completely open.

8. The apparatus as claimed in at least one of claims 6 and 7, characterized in that
a) the first air supply actuating member (21) is installed in a supply line (2) which preferably comprises a front and a rear supply line section (28,29), with the front supply line section (28) leading to the air supply fan (B) and with the rear supply line section (29) opening into the air circulation zone (11); and
b) the first exhaust air actuating member (31) is installed in an exhaust line (3) which preferably comprises a front and a rear exhaust line section (38,39), with the front exhaust line section (38) opening into the air circulation zone (11), and the rear exhaust line section (39) leading to the air supply fan (B).

9. The apparatus as claimed in at least one of claims 6 to 8, characterized in that
a) the first air supply bypass (23) extends from the front supply line section (28) into the working chamber (10), or opens into the rear supply line section (29); and
b) the first exhaust air bypass (33) extends from the rear exhaust line section (39) into the working chamber (10), or opens into the front exhaust line section (38).

10. The apparatus as claimed in at least one of claims 6 to 9, characterized in that the means for measurement of the differential pressure on both sides of the first air supply actuating member (21) and/or of the first exhaust air actuating member (31)
a) is a differential pressure sensor which receives pressure signals which are tapped off at measurement points (40); in which case
aa) one measurement point (40) is in each case arranged downstream before the first air supply actuating member (21), and a further measurement point (40) is arranged downstream behind the first air supply actuating member (21);
ab) one measurement point (40) is in each case arranged downstream before the first exhaust air actuating member (31), and a further measurement point (40) is arranged downstream behind the first exhaust air actuating member (31); and
ac) the differential pressure sensor is preferably a component of an installation control unit (6); or
b) is a flowmeter which is arranged in the first air supply bypass (23) and/or in the first exhaust air bypass (33).

11. The apparatus as claimed in claim 10, characterized in that
a) in the case of the first air supply bypass (23), which opens into the working chamber (10), one of the measurement points (40) is arranged in the front supply line section (28), preferably in the area of the branch for the first air supply bypass (23), and the further measurement point (40) is arranged in the working chamber (10), preferably in the area of the opening of the first air supply bypass (23);
b) in the case of the first air supply bypass (23), which opens into the rear supply line section (29), one of the measurement points (40) is arranged in the front supply line section (28), preferably in the area of the branch of the first air supply bypass (23), and the further measurement point (40) is arranged in the rear supply line section (29), preferably in the area of the opening of the first air supply bypass (23); and
c) in the case of the first exhaust air bypass (33) which opens into the working chamber (10), one of the measurement points (40) is arranged in the rear exhaust line section (39), preferably in the area of the branch of the first exhaust air bypass (33), and the further measurement point (40) is arranged in the working chamber (10), preferably in the area of the opening of the first exhaust air bypass (33);
d) in the case of the first exhaust air bypass (33) which opens into the front exhaust line section (38), one of the measurement points (40) is arranged in the front exhaust line section (38), preferably in the area of the branch of the first exhaust air bypass (33), and the further measurement point (40) is arranged in the rear exhaust line section (39), preferably in the area of the opening of the first exhaust air bypass (33).

12. The apparatus as claimed in at least one of claims 6 to 11, characterized in that
a) the first air supply bypass (23) has an associated installation control unit (6) which is intended for detection of the differential pressure on both sides of the first air supply actuating member (21) and is connected to the air supply fan (B), to the first air supply actuating member (21) and to the second air supply actuating member (24); and
b) the first exhaust air bypass (33) has an associated installation control unit (6), which is intended for detection of the differential pressure on both sides of the first exhaust air actuating member (31), and is connected to the exhaust air fan (B), to the first exhaust air actuating member (31) and to the second exhaust air actuating member (34).

13. The apparatus as claimed in at least one of claims 6 to 12, characterized in that
a) the first air supply actuating member (21) is connected to a first air supply actuating drive (22), preferably an electric motor;
b) the first exhaust air actuating member (31) is connected to a first exhaust air actuating drive (32), preferably an electric motor;
c) the second air supply actuating member (24) is connected to a second air supply actuating drive (240), preferably an electric motor; and
d) the second exhaust air actuating member (34) is connected to a second exhaust air actuating drive (340), preferably an electric motor; in which case
e) the installation control unit (6) associated with the first air supply bypass (23) is connected to the first air supply actuating drive (22) and to the second air supply actuating drive (240);
f) the installation control unit (6) associated with the first exhaust air bypass (33) is connected to the first exhaust air actuating drive (32) and to the second exhaust air actuating drive (340).

14. The apparatus as claimed in at least one of claims 6 to 13, characterized in that
a) at least one air circulation unit (c0) is arranged in the air circulation zone (11) and comprises:
aa) an air circulation fan (B), which is driven by a motor (M), for feeding air from the air circulation zone (11) into the working chamber (10);
ab) a filter plenum (Fp), which is arranged downstream, before the air circulation fan (B); and
ac) an air filter (F), which is arranged downstream before the filter plenum (Fp) and is adjacent to the working chamber (10); and
b) two-point regulation is provided at the isolator (1), and comprises:
ba) a second exhaust air bypass (35), which originates from the rear exhaust line section (39) and opens into the filter plenum (Fp) of an air circulation unit (c1), and in which a third exhaust air actuating member (36), which is connected to a third exhaust air actuating drive (37), is installed; and/or
bb) a second air supply bypass, which originates from the front supply line section (28) and opens into the filter plenum (Fp) of an air circulation unit (c1), and in which a third air supply actuating member which is connected to a third air supply actuating drive is provided;
bc) a pressure sensor (33), which is arranged in the working chamber (10) and is connected to a two-point regulator (4);
bd) a compressed-air source (5), to which a compressed-air line (57) which opens into the air circulation zone (11) and is provided with a compressed-air actuating member (51) is connected, with the compressed-air actuating member (51) being connected to a compressed-air actuating drive (52);
be) if a second exhaust air bypass (35) is provided, the two-point regulator (4) is connected to the third exhaust air actuating drive (37) and to the compressed-air actuating drive (52); and
bf) if a second supply air bypass is provided, this two-point regulator (4) is connected to the third supply air actuating drive and to the compressed-air actuating drive (52).

15. The arrangement as claimed at least one of claims 6 to 14, characterized in that
a) an air filter (F), which may have a filter plenum (Fp), is arranged downstream before the air supply fan (B) in the air supply unit (a1,a2,a3), in order to clean the air flowing out of the external surrounding area (U) into the isolator (1);
b) an air filter (F) which may have a filter plenum (Fp) is arranged downstream before the exhaust air fan (B) in the exhaust air unit (b2,b3,b4,b5,b6) in order to clean the air which is emitted from the isolator (1) into the external surrounding area (U); and
c) a decontamination system with an evaporator is provided in the internal area (18) of the isolator (1).
